(19) United States
(12) Patent Application Publication
(10) Pub. No.: US 2023/0272214 A1
(43) Pub. Date: Aug. 31, 2023

(54) THERMOPLASTIC VULCANIZATE AND METHOD FOR PREPARING THE SAME

(71) Applicants: INDUSTRIAL TECHNOLOGY RESEARCH INSTITUTE, Hsinchu (TW); FORMOSA PLASTICS CORPORATION, Kaohsiung City (TW)

(72) Inventors: Jin-An WU, Huwei Township (TW); Fu-Ming CHIEN, Hsinchu City (TW); Yun-Chen CHANG, Taichung City (TW); Jen-Long WU, Kaohsiung City (TW); Wen-Hao KANG, Kaohsiung City (TW); Kuei-Pin LIN, Chiayi City (TW); Ying-Cheng WENG, Dounan Township (TW); Shih-Hsun LIN, Taichung City (TW)

(73) Assignees: INDUSTRIAL TECHNOLOGY RESEARCH INSTITUTE, Hsinchu (TW); FORMOSA PLASTICS CORPORATION, Kaohsiung City (TW)

(21) Appl. No.: 18/173,668

(22) Filed: Feb. 23, 2023

Related U.S. Application Data
(60) Provisional application No. 63/313,944, filed on Feb. 25, 2022.

(30) Foreign Application Priority Data
Aug. 18, 2022 (TW) 111131107

(51) Int. Cl. C08L 75/04; B29C 35/02; C08K 5/14; C08L 51/06; C08K 5/3492; C08L 19/00

(52) U.S. Cl. CPC C08L 75/04; B29C 35/02; C08K 5/14; C08L 51/06; C08K 5/34924; C08L 19/003; B29K 2101/12

(57) ABSTRACT

A thermoplastic vulcanizate and a method for preparing the same are provided. The thermoplastic vulcanizate includes a thermoplastic, a cross-linked rubber particle, and a compatibilizer, wherein the cross-linked rubber particle is dispersed in the thermoplastic serving as a continuous phase, wherein the cross-linked rubber particle is a product of a composition via a cross-linking reaction. The composition includes an ethylene copolymer and a cross-linking agent, wherein the weight ratio of the thermoplastic to the ethylene copolymer is 3:17 to 1:1.

### CROSS REFERENCE TO RELATED APPLICATIONS

This application claims priority to U.S. Provisional Application Ser. No. 63/313,944, filed on Feb. 25, 2022, the entirety of which is incorporated by reference herein. Further, the application claims priority of Taiwan Patent Application No. 111131107, filed on Aug. 18, 2022, the entirety of which is incorporated by reference herein.

### TECHNICAL FIELD

The disclosure relates to a thermoplastic vulcanizate and a method for preparing the same.

### BACKGROUND

Thermoplastic vulcanizate (TPV) is a polymer composition that includes a thermoplastic serving as a continuous phase (as known as thermoplastic matrix) in which a thermosetting elastomer is distributed. Unlike a conventional thermoplastic elastomer (TPE), TPV has thermoplastic properties at high temperatures, is compressible at room temperature, and demonstrates resistance to permanent deformation. As such, TPV can be used in several fields, including the automotive industry, consumer electronics, packaging materials, and encapsulation.

At present, the most common commercial thermoplastic vulcanizate (TPV) materials are ethylene-propylene-diene monomer/polypropylene (EPDM/PP) elastomer. Ethylene-propylene-diene monomer/polypropylene (EPDM/PP) elastomer, however, exhibits inferior tensile strength and resilience. Furthermore, due to the difference in surface polarity, the adhesion strength between EPDM/PP elastomer and another thermoplastic elastomer (such as thermoplastic polyester elastomer (TPEE), thermoplastic polyurethane elastomer (TPU), or thermoplastic polyamide elastomer (TPAE)) is insufficient.

Although there have been many studies conducted in this field and the products manufactured in this sector have been under long-term development, there still remain many problems with processing, as well as with the various properties of said products. Therefore, there have been calls for improvements to be made in this industry.

### SUMMARY

The disclosure provides a thermoplastic vulcanizate. According to embodiments of the disclosure, the thermoplastic vulcanizate can include a thermoplastic, a cross-linked rubber particle, and a compatibilizer. The cross-linked rubber particle is dispersed in the thermoplastic serving as a continuous phase. The cross-linked rubber particle may be a product of a composition via a cross-linking reaction, wherein the composition can include an ethylene copolymer and a cross-linking agent, and wherein the weight ratio of the thermoplastic to the ethylene copolymer may be 3:17 to 1:1.

According to some embodiments of the disclosure, the disclosure provides a method for preparing thermoplastic vulcanizate. The method for preparing thermoplastic vulcanizate includes subjecting a composition to a melt blending process to obtain a polymer blend, and mixing the cross-linking agent with the blend, such that the ethylene copolymer of the blend is subjected to a dynamic cross-linking process to obtain a thermoplastic vulcanizate. In particular, the composition includes 50-85 parts by weight of ethylene copolymer, 15-50 parts by weight of thermoplastic, 0.5-10 parts by weight of compatibilizer, wherein a total weight of the ethylene copolymer and the thermoplastic is 100 parts by weight. In addition, the amount of cross-linking agent is 0.2-2 parts by weight.

A detailed description is given in the following embodiments.

### BRIEF DESCRIPTION OF THE DRAWINGS

FIG. 1 shows a scanning electron microscope (SEM) photograph of Thermoplastic vulcanizate (2) according to Example 2.

FIG. 2 shows a scanning electron microscope (SEM) photograph of Blend (6) according to Comparative Example 6.

### DETAILED DESCRIPTION

The thermoplastic vulcanizate and the method for preparing the same are described in detail in the following description. It will be apparent, however, that the exemplary embodiments set forth herein are used merely for the purpose of illustration, and the inventive concept may be embodied in various forms without being limited to those exemplary embodiments. As used herein, the term “about” in quantitative terms refers to plus or minus an amount that is general and reasonable to persons skilled in the art.

According to embodiments of the disclosure, the disclosure provides a thermoplastic vulcanizate. The thermoplastic vulcanizate includes a thermoplastic serving as the continuous phase, and a cross-linked rubber particle serving as the dispersed phase. A compatibilizer is used to increase the compatibility between the thermoplastic and the ethylene copolymer (forming the cross-linked rubber particle via a cross-linking reaction) in the melt blending process. Therefore, the mechanical strength of the thermoplastic vulcanizate is increased. Due to the specific ratio between the thermoplastic and the ethylene copolymer, the cross-linked rubber particle (i.e. the reaction product of the ethylene copolymer and the cross-linking agent) serves as micro-nano dispersed particles evenly dispersed in thermoplastic vulcanizate via the melt blending process and the dynamic cross-linking process. Therefore, in comparison with conventional blending process (subjecting thermoplastic and rubber to a blending process at low temperature), the thermoplastic vulcanizate of the disclosure exhibits superior tensile strength, resilience, processability, compressibility, anti-permanent deformation, thermal stability, and foamability. In addition, the thermoplastic vulcanizate of the disclosure may be subjected to an injection molding process, extrusion molding process, or foaming molding process to obtain a product for use in the field of sporting goods or shoe soles.

According to embodiments of the disclosure, the thermoplastic vulcanizate of the disclosure may have a Shore A hardness of about 50A to 90A, such as about 55A, 60A, 65A, 70A, 75A, 80A, or 85A. The Shore A hardness of the thermoplastic vulcanizate of the disclosure is determined by the method according to ASTM D 2240.

According to embodiments of the disclosure, the thermoplastic vulcanizate of the disclosure may have a resilience of about 40% to 65%, such as about 45%, 50%, 55%, or 60%. The resilience of the thermoplastic vulcanizate of the disclosure is determined by the method according to ASTM D 2632-92.

According to embodiments of the disclosure, the thermoplastic vulcanizate can include a thermoplastic, a cross-linked rubber particle, and a compatibilizer, wherein the compatibilizer improves the compatibility between the thermoplastic and the cross-linked rubber particle, such that the cross-linked rubber particle is dispersed in the thermoplastic serving as a continuous phase. According to embodiments of the disclosure, the cross-linked rubber particle is a product of the cross-linking reaction of an ethylene copolymer and a cross-linking agent. According to embodiments of the disclosure, the weight ratio of the thermoplastic to the ethylene copolymer may be about 3:17 to 1:1, such as about 4:16, 5:15, 6:14, 7:13, 8:12, or 9:11. When the amount of ethylene copolymer is too low, the amount of cross-linked rubber particle in the thermoplastic vulcanizate is reduced, thereby reducing the compression set of the thermoplastic vulcanizate. When the amount of ethylene copolymer is too high, the dispersibility of cross-linked rubber particles is poor as a cross-linked rubber particle agglomerate is apt to be formed via particle aggregation; thus, the thermoplastic vulcanizate would exhibit reduced mechanical strength.

According to embodiments of the disclosure, the thermoplastic vulcanizate can include a continuous phase, a dispersed phase, and a compatibilizer, wherein the continuous phase includes thermoplastic, and the dispersed phase includes a plurality of cross-linked rubber particles. The compatibilizer improves the compatibility between the continuous phase (thermoplastic) and the dispersed phase (cross-linked rubber particle), such that the cross-linked rubber particle is dispersed in the thermoplastic serving as a continuous phase. According to some embodiments of the disclosure, the continuous phase may consist of the thermoplastic, and the dispersed phase may consist of the plurality of cross-linked rubber particles.

According to embodiments of the disclosure, the cross-linked rubber particle has a particle size of 0.2 μm to 5 μm, such as about 0.3 μm, 0.4 μm, 0.5 μm, 0.6 μm, 0.7 μm, 0.8 μm, 0.9 μm, 1 μm, 2 μm, 3 μm, or 4 μm. According to embodiments of the disclosure, when the particle size of the cross-linked rubber particle in the thermoplastic serving as a continuous phase is not properly reduced to within the range of the disclosure, the properties (such as tensile strength, resilience and compression set) of the thermoplastic vulcanizate would be deteriorated.

According to embodiments of the disclosure, the amount of compatibilizer may be about 0.5 wt % to 10 wt % (such as about 1 wt %, 2 wt %, 3 wt %, 4 wt %, 5 wt %, 6 wt %, 7 wt %, 8 wt %, or 9 wt %), based on the total weight of the thermoplastic and the ethylene copolymer. When the amount of compatibilizer is too low or the compatibilizer is absent, the compatibility between the thermoplastic and the ethylene copolymer (forming the cross-linked rubber particle via cross-linking reaction) in the melt blending process would not be improved, resulting that the particle size of cross-linked rubber particle would not be within the range of 0.2 μm to 5 μm and the properties of the thermoplastic vulcanizate are deteriorated. When the amount of compatibilizer is greater than 10 wt %, the microphase separation configuration of the thermoplastic and the ethylene copolymer in the melt blending process is impacted such that the cross-linked rubber particles are not evenly dispersed in the thermoplastic vulcanizate. Therefore, the properties of the thermoplastic vulcanizate are deteriorated.

According to embodiments of the disclosure, the amount of cross-linking agent may be about 0.2 wt % to 2 wt % (such as about 0.3 wt %, 0.4 wt %, 0.5 wt %, 0.6 wt %, 0.7 wt %, 0.8 wt %, 0.9 wt %, 1 wt %, 1.2 wt %, or 1.5 wt %), based on the total weight of the thermoplastic and the ethylene copolymer. When the amount of cross-linking agent is too low, the cross-linking degree of the ethylene copolymer would be insufficient and a phase inversion in the melt blending process would not be formed to obtain cross-linked rubber particles evenly dispersed in the thermoplastic serving as a continuous phase. Therefore, the properties of the thermoplastic vulcanizate are deteriorated. When the amount of cross-linking agent is too high, the agglomerate of the cross-linked rubber particles would be formed due to the increased cross-linking speed of the ethylene copolymer, and thus the properties of the thermoplastic vulcanizate are deteriorated.

According to embodiments of the disclosure, the ethylene copolymer may be ethylene-vinyl acetate copolymer (EVA), ethylene-vinyl acetate rubber (EVM), ethylene-acrylic acid copolymer (EAA), ethylene-methacrylic acid copolymer (EMAA), ethylene-methyl acrylate copolymer (EMA), ethylene-ethyl acrylate copolymer (EEA), ethylene-butyl acrylate copolymer (EBA), or a combination thereof. Herein, the ethylene-vinyl acetate copolymer (EVA) may have a vinyl acetate content (i.e. the weight percentage of the repeating units derived from vinyl acetate) of less than 40 wt %, such as about greater than or equal to 15 wt % and less than 40 wt %. In addition, the ethylene-vinyl acetate rubber (EVM) may have a vinyl acetate content (i.e. the weight percentage of the repeating units derived from vinyl acetate) not greater than 40 wt %, such as about greater than or equal to 15 wt % and less than 40 wt %. According to embodiments of the disclosure, the ethylene copolymer may have a number average molecular weight (Mn) of about 2,000 g/mol to 500,000 g/mol, such as 3,000 g/mol, 4,000 g/mol, 5,000 g/mol, 8,000 g/mol, 10,000 g/mol, 20,000 g/mol, 30,000 g/mol, 50,000 g/mol, 80,000 g/mol, 100,000 g/mol, 150,000 g/mol, 200,000 g/mol, or 300,000 g/mol. The number average molecular weight (Mn) of the ethylene copolymer of the disclosure may be determined by gel permeation chromatography (GPC) based on a polystyrene calibration curve.

According to embodiments of the disclosure, the thermoplastic may be polypropylene (PP), polyethylene (PE), thermoplastic polyurethane (TPU), polyethylene terephthalate (PET), polyamide, or a combination thereof. According to embodiments of the disclosure, the thermoplastic may have a number average molecular weight (Mn) of about 10,000 g/mol to 5,000,000 g/mol, such as 20,000 g/mol, 30,000 g/mol, 40,000 g/mol, 50,000 g/mol, 80,000 g/mol, 100,000 g/mol, 200,000 g/mol, 300,000 g/mol, 500,000 g/mol, 800,000 g/mol, 1,000,000 g/mol, 1,500,000 g/mol, 2,000,000 g/mol, 3,000,000 g/mol, or 4,000,000 g/mol. The number average molecular weight (Mn) of the thermoplastic of the disclosure may be determined by gel permeation chromatography (GPC) based on a polystyrene calibration curve.

According to embodiments of the disclosure, the thermoplastic of the disclosure is not further modified and does not have reactivity. Namely, the thermoplastic does not have a reactive functional group in order to prevent the thermoplastic from reacting with the ethylene copolymer in the melt blending process or dynamic cross-linking process. Therefore, the cross-linking density of the cross-linked rubber particle and the properties of thermoplastic vulcanizate are deteriorated. According to embodiments of the disclosure, the reactive functional group may be acrylate group, methacrylate group, glycidyl group, oxiranyl group, oxetanyl group, or (3,4-epoxycyclohexyl) methyl group. According to embodiments of the disclosure, the thermoplastic does not include silane-containing thermoplastic, or siloxane-containing thermoplastic. Namely, the thermoplastic of the disclosure is a polymer without silane moiety or siloxane moiety.

According to embodiments of the disclosure, the compatibilizer may be a maleic-anhydride-grafted polymer or a maleic-anhydride-grafted copolymer, wherein the maleic anhydride grafting ratio of the maleic-anhydride-grafted polymer or the maleic-anhydride-grafted copolymer may be about 0.3% to 2.0% (such as about 0.4%, 0.5%, 0.6%, 0.7%, 0.8%, 0.9%, 1%, 1.2%, 1.5%, or 1.8%). Herein, the maleic anhydride grafting ratio means the percentage of the amount of hydrogen, which is replaced with maleic anhydride group, in all repeating units of the polymer or copolymer. According to embodiments of the disclosure, the compatibilizer may be maleic anhydride grafted polyethylene (PE-g-MAH), maleic anhydride grafted ethylene-vinyl acetate copolymer (EVA-g-MAH), maleic anhydride grafted polyethylene-octene (POE-g-MAH), maleic anhydride grafted ethylene-propylene-diene monomer (EPDM-g-MAH), maleic anhydride grafted styrene-ethylene-butadiene-styrene block copolymer (SEBS-g-MAH), or a combination thereof. According to embodiments of the disclosure, the maleic-anhydride-grafted polymer (or maleic-anhydride-grafted copolymer) may have a number average molecular weight (Mn) of about 2,000 g/mol to 100,000 g/mol, such as 3,000 g/mol, 4,000 g/mol, 5,000 g/mol, 8,000 g/mol, 10,000 g/mol, 20,000 g/mol, 30,000 g/mol, 50,000 g/mol, or 80,000 g/mol. The number average molecular weight (Mn) of the maleic-anhydride-grafted polymer (or maleic-anhydride-grafted copolymer) of the disclosure may be determined by gel permeation chromatography (GPC) based on a polystyrene calibration curve.

According to embodiments of the disclosure, the compatibilizer may be a compatibilizer commercially available from Dow Chemical Company with a trade number of AMPLIFY™ TY 1053H, AMPLIFY™ TY 1057H, AMPLIFY™ TY 1052H, or AMPLIFY™ TY 1151. The compatibilizer may be a compatibilizer commercially available from DuPont with a trade number of BYNEL 41E710, BYNEL 4033, BYNEL 4140, Fusabond E series or Fusabond M series. The compatibilizer may be a compatibilizer commercially available from Arkema with a trade number of OREVAC OE825.

According to embodiments of the disclosure, the cross-linking agent may be a peroxide. According to embodiments of the disclosure, the cross-linking agent may be benzoyl peroxide, 1,1-bis (tert-butylperoxy)cyclohexane), 2,5-bis (tert-butylperoxy)-2,5-dimethylcyclohexane, 2,5-bis (tert-butylperoxy)-2,5-dimethyl-3-cyclohexyne, bis (1-(tert-butylpeorxy)-1-methy-ethyl)benzene, tert-butyl hydroperoxide, tert-butyl peroxide, tert-butyl peroxybenzoate, cumene hydroperoxide, cyclohexanone peroxide, dicumyl peroxide, lauroyl peroxide, or a combination thereof.

According to embodiments of the disclosure, the composition for forming the cross-linked rubber particle via cross-linking reaction may further include a cross-linking aid, wherein the amount of cross-linking aid may be 0.1 wt % to 2 wt % (such as about 0.2%, 0.3%, 0.4%, 0.5%, 0.6%, 0.7%, 0.8%, 0.9%, 1%, 1.2%, 1.5%, or 1.8%), based on the total weight of the thermoplastic and the ethylene copolymer. According to embodiments of the disclosure, the cross-linking aid may be triallyl cyanurate (TAC), triallyl isocyanurate (TAIC), triallylphosphate (TAP), triallyl borate (TAB), trimethallyl isocyanurate (TMAIC), trimethylolpropane triacrylate (TMPTA), trimethylolpropane trimethacrylate, or a combination thereof.

According to embodiments of the disclosure, the cross-linked rubber particle is a cross-linked ethylene copolymer. According to embodiments of the disclosure, the composition for forming the cross-linked rubber particle consists of ethylene copolymer and cross-linking agent. According to embodiments of the disclosure, the composition for forming the cross-linked rubber particle consists of ethylene copolymer, cross-linking agent and cross-linking aid. According to embodiments of the disclosure, the composition for forming the cross-linked rubber particle does not include any other polymer or copolymer (for undergoing cross-linking reaction) except ethylene copolymer. According to embodiments of the disclosure, the thermoplastic vulcanizate of the disclosure does not include polyisobutylene (PIB), ethylene propylene rubber (EPR), or ethylene propylene diene monomer (EPDM).

According to embodiments of the disclosure, the composition for forming the cross-linked rubber particle may undergo a cross-linking reaction in the presence of an antioxidant, wherein the amount of antioxidant is 0.1 wt % to 5 wt % (such as about 0.2%, 0.3%, 0.4%, 0.5%, 0.6%, 0.7%, 0.8%, 0.9%, 1%, 1.2%, 1.5%, 2%, 3%, or 4%), based on the total weight of the thermoplastic and the ethylene copolymer. According to embodiments of the disclosure, the antioxidant may be hindered phenol antioxidant, thioester antioxidant, or phosphite antioxidant.

According to embodiments of the disclosure, the disclosure also provides a method for preparing thermoplastic vulcanizate of the disclosure. According to embodiments of the disclosure, the method for preparing thermoplastic vulcanizate includes subjecting a composition to a melt blending process to obtain a polymer blend, and mixing 0.2-2 parts by weight of cross-linking agent with the polymer blend such that the ethylene copolymer of the polymer blend is subjected to a dynamic cross-linking process to obtain a thermoplastic vulcanizate.

According to embodiments of the disclosure, the composition can include 50-85 parts by weight (such as about 55 parts by weight, 60 parts by weight, 65 parts by weight, 70 parts by weight, 75 parts by weight, or 80 parts by weight) of ethylene copolymer, 15-50 parts by weight (such as about 20 parts by weight, 25 parts by weight, 30 parts by weight, 35 parts by weight, 40 parts by weight, or 45 parts by weight) of thermoplastic, 0.5-10 parts by weight (such as about 1 part by weight, 2 parts by weight, 3 parts by weight, 4 parts by weight, 5 parts by weight, 6 parts by weight, 7 parts by weight, 8 parts by weight, or 9 parts by weight) of compatibilizer, wherein a total weight of the ethylene copolymer and the thermoplastic is 100 parts by weight.

Herein, the term “blending” in the disclosure means a process for mixing the rubber (or the plastic) with the reagent (such as the cross-linking agent, cross-linking aid and antioxidant) by mechanical action (such as extrusion), and the blending step can be performed in a continuous manner or a batch-wise manner. The term “dynamic cross-linking process” means during the ethylene copolymer and the thermoplastic being melted and blended, the polymer blend is mixed with a cross-linking agent (and a cross-linking aid) to form cross-link between the ethylene copolymer molecules. The term “dynamic” means applying a shear force to the mixture during cross-linking process.

To let the ethylene copolymer and the thermoplastic melt and mix more evenly, a temperature during the mixing process may be adjusted to between the melting point temperature and the decompose temperature of the thermoplastic. According to embodiments of the disclosure, the melt blending process may have a temperature of about 170° C. to 200° C. According to embodiments of the disclosure, the dynamic cross-linking process may have a temperature of about 170° C. to 200° C.

According to embodiments of the disclosure, in the method for preparing thermoplastic vulcanizate of the disclosure, the composition may be subjected to the melt blending process via banbury mixer, kneader, single-screw extruder, or twin-screw extruder, and thus the ethylene copolymer in the polymer blend is subjected to a dynamic cross-linking process.

According to embodiments of the disclosure, when performing melt blending process and dynamic cross-linking process via a twin-screw extruder, the twin-screw extruder may have a screw speed of about 150 rpm to 400 rpm. According to embodiments of the disclosure, after obtaining the thermoplastic vulcanizate via dynamic cross-linking process, the obtained thermoplastic vulcanizate may be subjected to a drying process (with a temperature of 80° C. to 100° C. for 6 hours to 8 hours), pelletizing process, or foaming process.

According to embodiments of the disclosure, the composition can further include 0.1-2 parts by weight of cross-linking aid. According to embodiments of the disclosure, the composition can further include 0.1-5 parts by weight of antioxidant. According to embodiments of the disclosure, the composition may consist of ethylene copolymer, thermoplastic, and compatibilizer. According to embodiments of the disclosure, the composition may consist of ethylene copolymer, thermoplastic, compatibilizer, and cross-linking aid. According to embodiments of the disclosure, the composition may consist of ethylene copolymer, thermoplastic, compatibilizer, cross-linking aid, and antioxidant. According to embodiments of the disclosure, the composition does not include other polymers or copolymers except the ethylene copolymer and thermoplastic. According to embodiments of the disclosure, the composition does not include polyisobutylene (PIB), ethylene propylene rubber (EPR), or ethylene propylene diene monomer (EPDM).

Below, exemplary embodiments will be described in detail so as to be easily realized by a person having ordinary knowledge in the art. The inventive concept may be embodied in various forms without being limited to the exemplary embodiments set forth herein.

### EXAMPLES

### Preparation of Thermoplastic Vulcanizate

### Example 1

69.07 parts by weight of ethylene-vinyl acetate copolymer (EVA) (commercially available from Taisox with a trade number of EVA 7470K), 30.93 parts by weight of thermoplastic polyurethane (TPU) (commercially available from Lubrizol with a trade number of S385A), 1.03 parts by weight of compatibilizer (maleic anhydride grafted ethylene-vinyl acetate copolymer (EVA-g-MAH), commercially available from Exxon with a trade number of VA1801), and 1.55 parts by weight of cross-linking aid (triallyl cyanurate (TAC), commercially available from Mitsubishi Chemicals Corp) were added into a twin-screw extruder (available under the trade designation of Coperion ZSK26) (with a screw diameter of 26 mm, L/D=60) to perform a melt blending process (with a temperature of 200° C. and a screw speed of 300 rpm). After blending for 1 minute, 0.52 parts by weight of cross-linking agent (commercially available from Arkema with a trade number of Luperox® 101) was added into the extruder to perform the dynamic cross-linking process (with a temperature of 200° C. and a screw speed of 300 rpm). After 1 minute, the result was subjected to a pelletization via a pelletizer (GZML-110L-150), obtaining Thermoplastic vulcanizate (1). The components and amounts thereof for preparing Thermoplastic vulcanizate (1) are shown in Table 1.

Next, the hardness, tensile strength, and resilience of Thermoplastic vulcanizate (1) were measured, and the results are shown in Table 2. The surface hardness was determined by the method according to ASTM D 2240; the tensile strength was determined by the method according to ASTM D412; and, the resilience was determined by the method according to ASTM D 2632-92.

### Example 2

Example 2 was performed in the same manner as in Example 1, except that the amount of ethylene-vinyl acetate copolymer was reduced from 69.07 parts by weight to 67.74 parts by weight, the amount of thermoplastic polyurethane was increased from 30.93 parts by weight to 32.26 parts by weight, the amount of maleic anhydride grafted ethylene-vinyl acetate copolymer was increased from 1.03 parts by weight to 5.38 parts by weight, the amount of cross-linking agent was increased from 0.52 parts by weight to 0.54 parts by weight, and the amount of cross-linking aid was increased from 1.55 parts by weight to 1.61 parts by weight, obtaining Thermoplastic vulcanizate (2). The components and amounts thereof for preparing Thermoplastic vulcanizate (2) are shown in Table 1.

Next, the hardness, tensile strength, and resilience of Thermoplastic vulcanizate (2) were measured, and the results are shown in Table 2.

### Example 3

Example 3 was performed in the same manner as in Example 1, except that the amount of ethylene-vinyl acetate copolymer was increased from 69.07 parts by weight to 78.49 parts by weight, the amount of thermoplastic polyurethane was reduced from 30.93 parts by weight to 21.51 parts by weight, the amount of maleic anhydride grafted ethylene-vinyl acetate copolymer was increased from 1.03 parts by weight to 5.38 parts by weight, the amount of cross-linking agent was increased from 0.52 parts by weight to 0.54 parts by weight, and the amount of cross-linking aid was increased from 1.55 parts by weight to 1.61 parts by weight, obtaining Thermoplastic vulcanizate (3). The components and amounts thereof for preparing Thermoplastic vulcanizate (3) are shown in Table 1.

Next, the hardness, tensile strength, and resilience of Thermoplastic vulcanizate (3) were measured, and the results are shown in Table 2.

### Example 4

67.74 parts by weight of ethylene-vinyl acetate copolymer (EVA) (commercially available from Taisox with a trade number of EVA 7470K), 32.26 parts by weight of thermoplastic polyurethane (TPU) (commercially available from Lubrizol with a trade number of S190A), 5.38 parts by weight of compatibilizer (maleic anhydride grafted polyethylene (PE-g-MAH), commercially available from Du Pont with a trade number of Fusabond E100), and 1.61 parts by weight of cross-linking aid (triallyl cyanurate (TAC), commercially available from Mitsubishi Chemicals Corp) were added into a twin-screw extruder (available under the trade designation of Coperion ZSK26) (with a screw diameter of 26 mm, L/D=60) to perform a melt blending process (with a temperature of 200° C. and a screw speed of 300 rpm). After blending for 1 minute, 0.54 parts by weight of cross-linking agent (commercially available from Arkema with a trade number of Luperox® 101) was added into the extruder to perform the dynamic cross-linking process (with a temperature of 200° C. and a screw speed of 300 rpm). After 1 minute, the result was subjected to pelletization via a pelletizer (GZML-110L-150), obtaining Thermoplastic vulcanizate (4). The components and amounts thereof for preparing Thermoplastic vulcanizate (4) are shown in Table 1.

Next, the hardness, tensile strength, and resilience of Thermoplastic vulcanizate (4) were measured, and the results are shown in Table 2.

### Example 5

Example 5 was performed in the same manner as in Example 1, except that the ethylene-vinyl acetate copolymer was reduced from 69.07 parts by weight to 67.57 parts by weight, the amount of thermoplastic polyurethane was increased from 30.93 parts by weight to 32.43 parts by weight, the amount of maleic anhydride grafted ethylene-vinyl acetate copolymer was increased from 1.03 parts by weight to 5.41 parts by weight, the amount of cross-linking agent was increased from 0.52 parts by weight to 1.08 parts by weight, and the amount of cross-linking aid was increased from 1.55 parts by weight to 1.62 parts by weight, obtaining Thermoplastic vulcanizate (5). The components and amounts thereof for preparing Thermoplastic vulcanizate (5) are shown in Table 1.

Next, the hardness, tensile strength, and resilience of Thermoplastic vulcanizate (5) were measured, and the results are shown in Table 2.

### Example 6

Example 6 was performed in the same manner as in Example 1, except that the ethylene-vinyl acetate copolymer was reduced from 69.07 parts by weight to 67.57 parts by weight, the amount of thermoplastic polyurethane was increased from 30.93 parts by weight to 32.43 parts by weight, the amount of maleic anhydride grafted ethylene-vinyl acetate copolymer was increased from 1.03 parts by weight to 5.41 parts by weight, the amount of cross-linking agent was increased from 0.52 parts by weight to 0.54 parts by weight, and the amount of cross-linking aid was increased from 1.55 parts by weight to 2.16 parts by weight, obtaining Thermoplastic vulcanizate (6). The components and amounts thereof for preparing Thermoplastic vulcanizate (6) are shown in Table 1.

Next, the hardness, tensile strength, and resilience of Thermoplastic vulcanizate (6) were measured, and the results are shown in Table 2.

### Example 7

Example 7 was performed in the same manner as in Example 1, except that the ethylene-vinyl acetate copolymer was reduced from 69.07 parts by weight to 67.74 parts by weight, the amount of thermoplastic polyurethane was increased from 30.93 parts by weight to 32.26 parts by weight, the amount of maleic anhydride grafted ethylene-vinyl acetate copolymer was increased from 1.03 parts by weight to 5.38 parts by weight, 0.52 parts by weight of Luperox® 101 was replaced with 0.54 parts by weight of DCP (dicumyl peroxide, commercially available from Keeneyes Industrial Corp), and the amount of cross-linking aid was increased from 1.55 parts by weight to 1.61 parts by weight, obtaining Thermoplastic vulcanizate (7). The components and amounts thereof for preparing Thermoplastic vulcanizate (7) are shown in Table 1.

Next, the hardness, tensile strength, and resilience of Thermoplastic vulcanizate (7) were measured, and the results are shown in Table 2.

### Example 8

Example 8 was performed in the same manner as in Example 1, except that the ethylene-vinyl acetate copolymer was reduced from 69.07 parts by weight to 56.99 parts by weight, the amount of thermoplastic polyurethane was increased from 30.93 parts by weight to 43.01 parts by weight, the amount of maleic anhydride grafted ethylene-vinyl acetate copolymer was increased from 1.03 parts by weight to 5.38 parts by weight, the amount of cross-linking agent was increased from 0.52 parts by weight to 0.54 parts by weight, and the amount of cross-linking aid was increased from 1.55 parts by weight to 1.61 parts by weight, obtaining Thermoplastic vulcanizate (8). The components and amounts thereof for preparing Thermoplastic vulcanizate (8) are shown in Table 1.

Next, the hardness, tensile strength, and resilience of Thermoplastic vulcanizate (8) were measured, and the results are shown in Table 2.

### Example 9

Example 9 was performed in the same manner as in Example 1, except that the ethylene-vinyl acetate copolymer was reduced from 69.07 parts by weight to 67.57 parts by weight, the amount of thermoplastic polyurethane was increased from 30.93 parts by weight to 32.43 parts by weight, the amount of maleic anhydride grafted ethylene-vinyl acetate copolymer was increased from 1.03 parts by weight to 5.41 parts by weight, the amount of cross-linking agent was increased from 0.52 parts by weight to 1.62 parts by weight, and the amount of cross-linking aid was reduced from 1.55 parts by weight to 0.54 parts by weight, obtaining Thermoplastic vulcanizate (9). The components and amounts thereof for preparing Thermoplastic vulcanizate (9) are shown in Table 1.

Next, the hardness, tensile strength, and resilience of Thermoplastic vulcanizate (9) were measured, and the results are shown in Table 2.

### Comparative Example 1

68.42 parts by weight of ethylene-vinyl acetate copolymer (EVA) (commercially available from Taisox with a trade number of EVA 7470K), 31.58 parts by weight of thermoplastic polyurethane (TPU), (commercially available from Lubrizol with a trade number of S385A), and 5.26 parts by weight of compatibilizer (maleic anhydride grafted ethylene-vinyl acetate copolymer (EVA-g-MAH), commercially available from Exxon with a trade number of VA1801) were added into a twin-screw extruder (available under the trade designation of Coperion ZSK26) (with a screw diameter of 26 mm, L/D=60) to perform a blending process (with a temperature of 190° C. and a screw speed of 300 rpm). After 1 minute, the result was subjected to pelletization via a pelletizer (GZML-110L-150), obtaining Blend (1). The components and amounts thereof for preparing Blend (1) are shown in Table 1.

Next, the hardness, tensile strength, and resilience of Blend (1) were measured, and the results are shown in Table 2.

### Comparative Example 2

70 parts by weight of ethylene-vinyl acetate copolymer (EVA) (commercially available from Taisox with a trade number of EVA 7470K), and 30 parts by weight of thermoplastic polyurethane (thermal polyurethane, TPU) (commercially available from Lubrizol with a trade number of S385A) were added into a twin-screw extruder (available under the trade designation of Coperion ZSK26) (with a screw diameter of 26 mm, L/D=60) to perform a blending process (with a temperature of 190° C. and a screw speed of 300 rpm). After 1 minute, the result was subjected to pelletization via a pelletizer (GZML-110L-150), obtaining Blend (2). The components and amounts thereof for preparing Blend (2) are shown in Table 1.

Next, the hardness, tensile strength, and resilience of Blend (2) were measured, and the results are shown in Table 2.

### Comparative Example 3

78.95 parts by weight of ethylene-vinyl acetate copolymer (EVA) (commercially available from Taisox with a trade number of EVA 7470K), 21.05 parts by weight of thermoplastic polyurethane (thermal polyurethane, TPU) (commercially available from Lubrizol with a trade number of S385A), and 5.26 parts by weight of compatibilizer (maleic anhydride grafted ethylene-vinyl acetate copolymer (EVA-g-MAH), commercially available from Exxon with a trade number of VA1801) were added into a twin-screw extruder (available under the trade designation of Coperion ZSK26) (with a screw diameter of 26 mm, L/D=60) to perform a blending process (with a temperature of 190° C. and a screw speed of 300 rpm). After 1 minute, the result was subjected to pelletization via a pelletizer (GZML-110L-150), obtaining Blend (3). The components and amounts thereof for preparing Blend (3) are shown in Table 1.

Next, the hardness, tensile strength, and resilience of Blend (3) were measured, and the results are shown in Table 2.

### Comparative Example 4

68.42 parts by weight of ethylene-vinyl acetate copolymer (EVA) (commercially available from Taisox with a trade number of EVA 7470K), 31.58 parts by weight of thermoplastic polyurethane (thermal polyurethane, TPU) (commercially available from Lubrizol with a trade number of S385A), and 5.26 parts by weight of compatibilizer (maleic anhydride grafted polyethylene (PE-g-MAH), commercially available from Du Pont with a trade number of Fusabond E100) were added into a twin-screw extruder (available under the trade designation of Coperion ZSK26) (with a screw diameter of 26 mm, L/D=60) to perform a blending process (with a temperature of 190° C. and a screw speed of 300 rpm). After 1 minute, the result was subjected to pelletization via a pelletizer (GZML-110L-150), obtaining Blend (4). The components and amounts thereof for preparing Blend (4) are shown in Table 1.

Next, the hardness, tensile strength, and resilience of Blend (4) were measured, and the results are shown in Table 2.

### Comparative Example 5

67.91 parts by weight of ethylene-vinyl acetate copolymer (EVA) (commercially available from Taisox with a trade number of EVA 7470K), 32.09 parts by weight of thermoplastic polyurethane (thermal polyurethane, TPU) (commercially available from Lubrizol with a trade number of S385A), 5.35 parts by weight of compatibilizer (maleic anhydride grafted ethylene-vinyl acetate copolymer (EVA-g-MAH), commercially available from Exxon with a trade number of VA1801), and 1.60 parts by weight of cross-linking aid (triallyl cyanurate (TAC), commercially available from Mitsubishi Chemicals Corp) were added into a twin-screw extruder (available under the trade designation of Coperion ZSK26) (with a screw diameter of 26 mm, L/D=60) to perform a blending process (with a temperature of 190° C. and a screw speed of 300 rpm). After 1 minute, the result was subjected to pelletization via a pelletizer (GZML-110L-150), obtaining Blend (5). The components and amounts thereof for preparing Blend (5) are shown in Table 1.

Next, the hardness, tensile strength, and resilience of Blend (5) were measured, and the results are shown in Table 2.

### Comparative Example 6

68.25 parts by weight of ethylene-vinyl acetate copolymer (EVA) (commercially available from Taisox with a trade number of EVA 7470K), 31.75 parts by weight of thermoplastic polyurethane (Thermal polyurethane, TPU) (commercially available from Lubrizol with a trade number of S385A), 5.29 parts by weight of compatibilizer (maleic anhydride grafted ethylene-vinyl acetate copolymer (EVA-g-MAH), commercially available from Exxon with a trade number of VA1801), and 0.53 parts by weight of cross-linking agent (commercially available from Arkema with a trade number of Luperox® 101) were added into a twin-screw extruder (available under the trade designation of Coperion ZSK26) (with a screw diameter of 26 mm, L/D=60) to perform a blending process (with a temperature of 190° C. and a screw speed of 300 rpm). After 1 minute, the result was subjected to pelletization via a pelletizer (GZML-110L-150), obtaining Blend (6). The components and amounts thereof for preparing Blend (6) are shown in Table 1.

Next, the hardness, tensile strength, and resilience of Blend (6) were measured, and the results are shown in Table 2.

### Comparative Example 7

43.01 parts by weight of ethylene-vinyl acetate copolymer (EVA) (commercially available from Taisox with a trade number of EVA 7470K), 56.99 parts by weight of thermoplastic polyurethane (Thermal polyurethane, TPU) (commercially available from Lubrizol with a trade number of S385A), and 5.38 parts by weight of compatibilizer (maleic anhydride grafted ethylene-vinyl acetate copolymer (EVA-g-MAH), commercially available from Exxon with a trade number of VA1801) were added into a twin-screw extruder (available under the trade designation of Coperion ZSK26) (with a screw diameter of 26 mm, L/D=60) to perform a blending process (with a temperature of 190° C. and a screw speed of 300 rpm). After 1 minute, the result was subjected to pelletization via a pelletizer (GZML-110L-150), obtaining Blend (7). The components and amounts thereof for preparing Blend (7) are shown in Table 1.

Next, the hardness, tensile strength, and resilience of Blend (7) were measured, and the results are shown in Table 2.

### Comparative Example 8

43.01 parts by weight of ethylene-vinyl acetate copolymer (EVA) (commercially available from Taisox with a trade number of EVA 7470K), 56.99 parts by weight of thermoplastic polyurethane (Thermal polyurethane, TPU) (commercially available from Lubrizol with a trade number of S385A), 5.38 parts by weight of compatibilizer (maleic anhydride grafted ethylene-vinyl acetate copolymer (EVA-g-MAH), commercially available from Exxon with a trade number of VA1801), 1.61 parts by weight of cross-linking aid (triallyl cyanurate (TAC), commercially available from Mitsubishi Chemicals Corp) and 0.54 parts by weight of cross-linking agent (commercially available from Arkema with a trade number of Luperox® 101) were added into a twin-screw extruder (available under the trade designation of Coperion ZSK26) (with a screw diameter of 26 mm, L/D=60) to perform a blending process (with a temperature of 190° C. and a screw speed of 300 rpm). After 1 minute, the result was subjected to pelletization via a pelletizer (GZML-110L-150), obtaining Blend (8). The components and amounts thereof for preparing Blend (8) are shown in Table 1.

Next, the hardness, tensile strength, and resilience of Blend (8) were measured, and the results are shown in Table 2.

Table 1

TABLE 1

| | EVA | TPU | EVA-g-MAH | PE-g-MAH | TAC | L101 | DCP |
|---|---|---|---|---|---|---|---|
| | (parts by | (parts by | (parts by | (parts by | (parts by | (parts by | (parts by |
| | weight ) | weight ) | weight ) | weight ) | weight ) | weight ) | weight ) |
| Example 1 | 69.07 | 30.93 | 1.03 | — | 1.55 | 0.52 | — |
| Example 2 | 67.74 | 32.26 | 5.38 | — | 1.61 | 0.54 | — |
| Example 3 | 78.49 | 21.51 | 5.38 | — | 1.61 | 0.54 | — |
| Example 4 | 67.74 | 32.26 | 0.00 | 5.38 | 1.61 | 0.54 | — |
| Example 5 | 67.57 | 32.43 | 5.41 | — | 1.62 | 1.08 | — |
| Example 6 | 67.57 | 32.43 | 5.41 | — | 2.16 | 0.54 | — |
| Example 7 | 67.74 | 32.26 | 5.38 | — | 1.61 | 0.00 | 0.54 |
| Example 8 | 56.99 | 43.01 | 5.38 | — | 1.61 | 0.54 | — |
| Example 9 | 67.57 | 32.43 | 5.41 | — | 0.54 | 1.62 | — |
| Comparative | 68.42 | 31.58 | 5.26 | — | — | — | — |
| Example 1 | | | | | | | |
| Comparative | 70.00 | 30.00 | 0.00 | — | — | — | — |
| Example 2 | | | | | | | |
| Comparative | 78.95 | 21.05 | 5.26 | — | — | — | — |
| Example 3 | | | | | | | |
| Comparative | 68.42 | 31.58 | 0.00 | 5.26 | — | — | — |
| Example 4 | | | | | | | |
| Comparative | 67.91 | 32.09 | 5.35 | — | 1.60 | — | — |
| Example 5 | | | | | | | |
| Comparative | 68.25 | 31.75 | 5.29 | — | — | 0.52 | — |
| Example 6 | | | | | | | |
| Comparative | 43.01 | 56.99 | 5.38 | — | — | — | — |
| Example 7 | | | | | | | |
| Comparative | 43.01 | 56.99 | 5.38 | — | 1.61 | 0.54 | — |
| Example 8 | | | | | | | |

TABLE 2

| | | tensile | |
|---|---|---|---|
| | hardness | strength | resilience |
| | (Shore A) | (kg/cm²) | (%) |
| Example 1 | 86 | 156 | 54% |
| Example 2 | 85 | 177 | 56% |
| Example 3 | 81 | 125 | 53% |
| Example 4 | 83 | 144 | 52% |
| Example 5 | 86 | 165 | 55% |
| Example 6 | 85 | 162 | 55% |
| Example 7 | 85 | 181 | 56% |
| Example 8 | 89 | 184 | 57% |
| Example 9 | 84 | 150 | 52% |
| Comparative Example 1 | 85 | 187 | 48% |
| Comparative Example 2 | 84 | 165 | 46% |
| Comparative Example 3 | 81 | 148 | 44% |
| Comparative Example 4 | 83 | 125 | 47% |
| Comparative Example 5 | 84 | 174 | 48% |
| Comparative Example 6 | 86 | 152 | 45% |
| Comparative Example 7 | 85 | 157 | 47% |
| Comparative Example 8 | 88 | 143 | 49% |

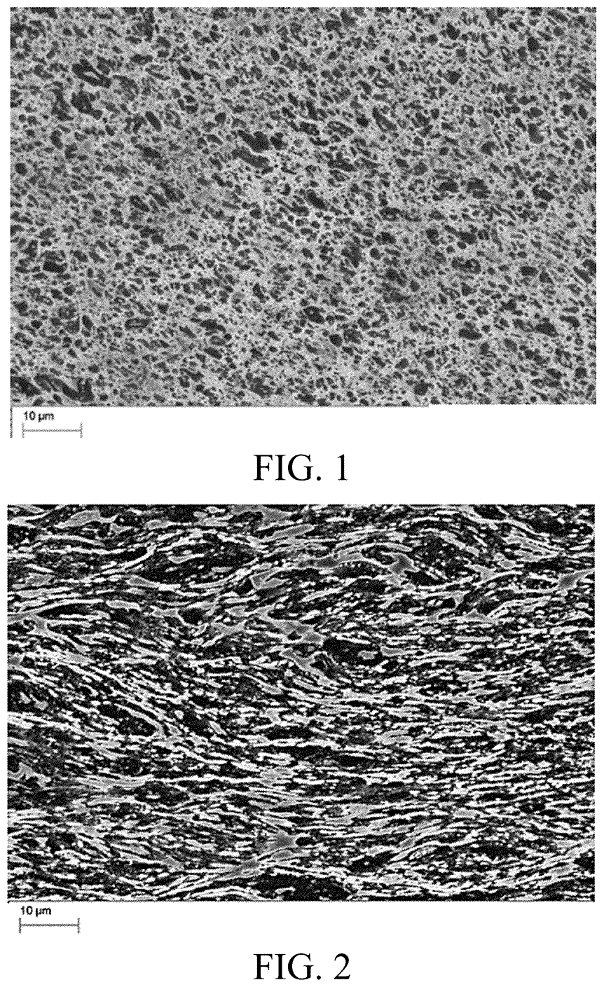

As shown in Table 2, due to the specific ratio between the thermoplastic and the ethylene copolymer, the melt blending process and the dynamic cross-linking process, the obtained thermoplastic vulcanizate (such as Thermoplastic vulcanizates (1)-(9) of Examples 1-9) exhibits high hardness (between 81 and 89), tensile strength (between 120 kg/cm² and 184 kg/cm²), and resilience (between 520%-57%). Namely, the thermoplastic vulcanizate of the disclosure has a superior resilience on the premise of maintaining high hardness and tensile strength. In addition, the polymer blends prepared from conventional blending process (subjecting thermoplastic and rubber to a blending process at low temperature) (such as Blends (1)-(4) of Comparative Examples 1-4) or prepared from blending process with the addition of a cross-linking agent or cross-linking aid (such as Blends (5) and (6) of Comparative Examples 5 and 6) exhibits poor resilience (less than 50%). It should be noted that it is a huge gap between a material having a resilience from 52% to 57% and a material having a resilience from 44% to 49%, and the material having a resilience from 52% to 57% exhibits a substantially higher performance in comparison with the material having a resilience from 44% to 49%. Next, the cross section of Thermoplastic vulcanizate (2) of Example 2 was observed by scanning electron microscope (SEM), and the result is shown in FIG. 1. In addition, the cross section of Blend (6) of Comparative Example 6 was observed by scanning electron microscope (SEM) and the result is shown in FIG. 2. As shown in FIG. 1, due to the melt blending process and the dynamic cross-linking process, the cross-linked rubber particle in Thermoplastic vulcanizate (1) serving as the dispersed phase is dispersed in the thermoplastic serving as a continuous phase, and the particle size of the cross-linked rubber particle is reduced to 5 μm or less. As shown in FIG. 2, since the ethylene-vinyl acetate copolymer (EVA) and the thermoplastic polyurethane (TPU) are blended at low temperature, the cross-linked ethylene-vinyl acetate copolymer is merely mixed with the thermoplastic polyurethane in spite of the addition of the cross-linking agent. The cross-linked ethylene-vinyl acetate copolymer does not remain in particulate form and could not be dispersed in the obtained result.

It will be clear that various modifications and variations can be made to the disclosed methods and materials. It is intended that the specification and examples be considered as exemplary only, with the true scope of the disclosure being indicated by the following claims and their equivalents.

What is claimed is:

1. A thermoplastic vulcanizate, comprising a thermoplastic, a cross-linked rubber particle, and a compatibilizer, wherein the cross-linked rubber particle is dispersed in the thermoplastic serving as a continuous phase, wherein the cross-linked rubber particle is a product of a composition via a cross-linking reaction, and the composition comprises an ethylene copolymer and a cross-linking agent, wherein the weight ratio of the thermoplastic to the ethylene copolymer is 3:17 to 1:1.

2. The thermoplastic vulcanizate as claimed in claim 1, wherein an amount of compatibilizer is 0.5 wt % to 10 wt %, and an amount of cross-linking agent is 0.2 wt % to 2 wt %, based on the total weight of the thermoplastic and the ethylene copolymer.

3. The thermoplastic vulcanizate as claimed in claim 1, wherein the cross-linked rubber particle has a particle size of 0.2 μm to 5 μm.

4. The thermoplastic vulcanizate as claimed in claim 1, wherein the ethylene copolymer is ethylene-vinyl acetate copolymer, ethylene-vinyl acetate rubber, ethylene-acrylic acid copolymer, ethylene-methacrylic acid copolymer, ethylene-methyl acrylate copolymer, ethylene-ethyl acrylate copolymer, ethylene-butyl acrylate copolymer, or a combination thereof.

5. The thermoplastic vulcanizate as claimed in claim 1, wherein the thermoplastic is polypropylene, polyethylene, thermoplastic polyurethane, polyethylene terephthalate, polyamide, or a combination thereof.

6. The thermoplastic vulcanizate as claimed in claim 1, wherein the compatibilizer is maleic anhydride grafted polyethylene, maleic anhydride grafted ethylene-vinyl acetate copolymer, maleic anhydride grafted polyethylene octene, maleic anhydride grafted ethylene-propylene-diene monomer, maleic anhydride grafted styrene-ethylene-butadiene-styrene block copolymer, or a combination thereof.

7. The thermoplastic vulcanizate as claimed in claim 1, wherein the cross-linking agent is a peroxide.

8. The thermoplastic vulcanizate as claimed in claim 1, wherein the cross-linking agent is benzoyl peroxide, 1,1-bis (tert-butylperoxy)cyclohexane, 2,5-bis (tert-butylperoxy)-2,5-dimethylcyclohexane, 2,5-bis (tert-butylperoxy)-2,5-dimethyl-3-cyclohexyne, bis (1-(tert-butylpeorxy)-1-methy-ethyl)benzene, tert-butyl hydroperoxide, tert-butyl peroxide, tert-butyl peroxybenzoate, cumene hydroperoxide, cyclohexanone peroxide, dicumyl peroxide, lauroyl peroxide, or a combination thereof.

9. The thermoplastic vulcanizate as claimed in claim 1, wherein the composition further comprises a cross-linking aid, wherein an amount of cross-linking aid is 0.1 wt % to 2 wt %, based on the total weight of the thermoplastic and the ethylene copolymer.

10. The thermoplastic vulcanizate as claimed in claim 9, wherein the cross-linking aid is triallyl cyanurate, triallyl isocyanurate, triallylphosphate, triallyl borate, trimethallyl isocyanurate, trimethylolpropane triacrylate, trimethylolpropane trimethacrylate, or a combination thereof.

11. A method for preparing thermoplastic vulcanizate, comprising:
subjecting a composition to a melt blending process, obtaining a blend wherein the composition comprises 50-85 parts by weight of ethylene copolymer, 15-50 parts by weight of thermoplastic, 0.5-10 parts by weight of compatibilizer, wherein a total weight of the ethylene copolymer and the thermoplastic is 100 parts by weight; and
mixing 0.2-2 parts by weight of a cross-linking agent with the blend, such that the ethylene copolymer of the blend is subjected to a dynamic cross-linking process, obtaining a thermoplastic vulcanizate.

12. The method as claimed in claim 11, wherein the melt blending process has a temperature of 170° C. to 200° C., and the dynamic cross-linking process has a temperature of 170° C. to 200° C.

13. The method as claimed in claim 11, wherein the ethylene copolymer is ethylene-vinyl acetate copolymer, ethylene-vinyl acetate rubber, ethylene-acrylic acid copolymer, ethylene-methacrylic acid copolymer, ethylene-methyl acrylate copolymer, ethylene-ethyl acrylate copolymer, ethylene-butyl acrylate copolymer, or a combination thereof.

14. The method as claimed in claim 11, wherein the thermoplastic is polypropylene, polyethylene, thermoplastic polyurethane, polyethylene terephthalate, polyamide, or a combination thereof.

15. The method as claimed in claim 11, wherein the compatibilizer is maleic anhydride grafted polyethylene, maleic anhydride grafted ethylene-vinyl acetate copolymer, maleic anhydride grafted polyethylene octene, maleic anhydride grafted ethylene-propylene-diene monomer, maleic anhydride grafted styrene-ethylene-butadiene-styrene block copolymer, or a combination thereof.

16. The method as claimed in claim 11, wherein the cross-linking agent is a peroxide.

17. The method as claimed in claim 11, wherein the cross-linking agent is benzoyl peroxide, 1,1-bis (tert-butylperoxy)cyclohexane, 2,5-bis (tert-butylperoxy)-2,5-dimethylcyclohexane, 2,5-bis (tert-butylperoxy)-2,5-dimethyl-3-cyclohexyne, bis (1-(tert-butylpeorxy)-1-methy-ethyl)benzene, tert-butyl hydroperoxide, tert-butyl peroxide, tert-butyl peroxybenzoate, cumene hydroperoxide, cyclohexanone peroxide, dicumyl peroxide, lauroyl peroxide, or a combination thereof.

18. The method as claimed in claim 11, wherein the composition further comprising:
a cross-linking aid, wherein an amount of cross-linking aid is 0.1 to 2 parts by weight.

19. The method as claimed in claim 18, wherein the cross-linking aid is triallyl cyanurate, triallyl isocyanurate, triallylphosphate, triallyl borate, trimethallyl isocyanurate, trimethylolpropane triacrylate, trimethylolpropane trimethacrylate, or a combination thereof.
